(19) United States
(12) Patent Application Publication
(10) Pub. No.: US 2019/0043064 A1
(43) Pub. Date: Feb. 7, 2019

(54) REAL-TIME QUALITATIVE ANALYSIS

(71) Applicant: Intel Corporation, Santa Clara, CA (US)

(72) Inventors: Siew Wen Chin, Penang (MY); Usman Sarwar, Penang (MY); Heng Kar Lau, Penang (MY); Shao-Wen Yang, San Jose, CA (US); Addicam V. Sanjay, Gilbert, AZ (US)

(21) Appl. No.: 15/939,557

(22) Filed: Mar. 29, 2018

(51) Int. Cl. G06Q 30/02

(52) U.S. Cl. CPC G06Q 30/0201; G06K 9/00355; G06Q 30/0282

(57) ABSTRACT

Monitoring and analyzing people interacting with an environment, e.g., looking around, touching, talking, exclaiming, moving items around, staring at something, walking, as well as producing identifiable physiological and/or movement that may be analyzed to determine a person's interest and/or emotional response to the environment. In a shopping context, analysis may determine customer interest in a specific product. Interest/emotional response may be translated into a quantified review and the reviews may be pushed peer-to-peer to others in the environment, used to update signage, propagated to social media, etc. Reviews may be determined in real time and if related to an unusual or negative review, may trigger one or more various responses, e.g., automatic assistance to clear up a problem, perform other error handling, notify a vendor of a problem, trigger an update such as to lower prices, etc.

### TECHNICAL FIELD

The present disclosure relates to real-time emotional and/or physiological qualitative analysis, and more particularly, to determining characteristics associated with a person, such as interest, based on analyzing the person's physiological state and/or movement.

### BACKGROUND AND DESCRIPTION OF RELATED ART

The advent of the Internet has enabled the ability for people to share their opinions and thoughts on any topic. It is therefore no surprise, most current-day consumers look to one or more online resources for information regarding local businesses trustworthiness. See, e.g., “Local Consumer Review Survey”, BrightLocal, at Internet Uniform Resource Locator (URL) www.brightlocal.com/learn/local-consumer-review-survey/(access date: 26th Oct. 2017):“97% of consumers aged 18-34 read online reviews to judge a local business and trust reviews as much as personal recommendation.” Online reviews are rapidly becoming the new word-of-mouth when it comes to business referral, e.g. books review from Amazon. See, for example, Kozinets, which discussed how word-of-mouth marketing is the intentional influencing of consumer-to-consumer communication by professional marketing technique. However, for brick-and-mortar retailers, most of the customer reviews will only be generated (if at all) post-purchase. It is therefore difficult for retailers to capture negative reviews which might ruin brand reputation before a customer leave a store. (Kozinets, Robert & Valck, Kristine & C. WOJNICKI, ANDREA & Wilner, Sarah. (2010). Networked Narratives: Understanding Word-of-Mouth Marketing in Online Communities. Journal of Marketing—J MARKETING. 74. 71-89. 10.1509/jmkg.74.2.71.)

Additionally, retailers are also facing Showrooming challenge where the shoppers visit a shop in order to examine a product only to later complete the purchase online at a lower price. This was a technique made famous by Amazon, and its smart-device based shopping app, that allows one to scan a barcode of a product, read reviews, and then easily order a product a customer evaluated in a store. Essentially, the brick-and-mortar retail stores became product showrooms for online shoppers. One way to address this problem, as discussed by Milchen, is to engage customers with great service and incentives. (See “Seven Ways Businesses and Communities Can Counter ‘Showrooming’”, Jeff Milchen and Casey Woods, American Independent Business Alliance, at Internet URL www.amiba.net/resources/showrooming/(access date: 26th Oct. 2017).) Polls have shown that over two-thirds of respondents thought in-store purchases were more reliable, and easier and more convenient to perform. Hence, retailers may take advantages of this and increase engagement between staff and/or the store environment and customers to convert showrooming back into in-store transactions.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary environment 100 illustrating an overview of tracking activity of a person, e.g., a customer, within an environment, e.g., a store.

FIG. 2 illustrates an exemplary environment 200 illustrating adaptive feedback and updating within an environment responsive to tracking activity of a person.

FIG. 3 illustrates an exemplary multi-modal framework 300 for tracking activity of a person in an environment with operations partitioned in accord with one embodiment of an Internet of Things (IoT) environment.

FIG. 4 illustrates an exemplary computer device 400 that may employ the apparatuses and/or methods described herein.

FIG. 5 illustrates an exemplary computer-accessible storage medium 500.

FIG. 6 illustrates a block diagram of a network illustrating communications among a number of IoT devices, according to an example.

FIG. 7 illustrates a block diagram for an example IoT processing system architecture 700 upon which any one or more of the techniques (e.g., operations, processes, methods, and methodologies) discussed herein may be performed, according to an example.

FIG. 8 illustrates a block diagram of a network illustrating communications among a number of IoT devices, according to an example.

FIG. 9 illustrates a block diagram for an example IoT processing system architecture upon which any one or more of the techniques (e.g., operations, processes, methods, and methodologies) discussed herein may be performed, according to an example.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations do not have to be performed in the order of presentation. Operations described may be performed in a different order than the described embodiment. Various additional operations may be performed and/or described operations may be omitted in additional embodiments. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are considered synonymous.

With reference to the abovementioned challenges, various disclosed and illustrated embodiments provide for real-time collecting and analyzing customer physiology and activity based at least in part on multi-sensory data collected regarding the customer, e.g. emotion, product engagement which may be translated into a quantitative review by a customer that may be publicly associated with the customer or kept anonymous if desired, that other customers may access as if reviews of products and/or in-store activities that might suggest a product or promotion is of interest by the other customer. Automated reviews may be pushed to or otherwise provided to other customers as an in-store word-of-mouth recommendation. The reviews may also be used to provide for automatically price-matching online retailers, updating digital signage (revise sales pitch, pricing, warranty, terms, etc.), relocating product (manually or through automatic placement systems), etc. Additionally, collected reviews provide immediate feedback to a retailer, allowing a retailer, for example, to detect anomaly responses associated with a product. This provides a unique opportunity for a retailer to manage possible customer relationship problems before a customer leaves a store.

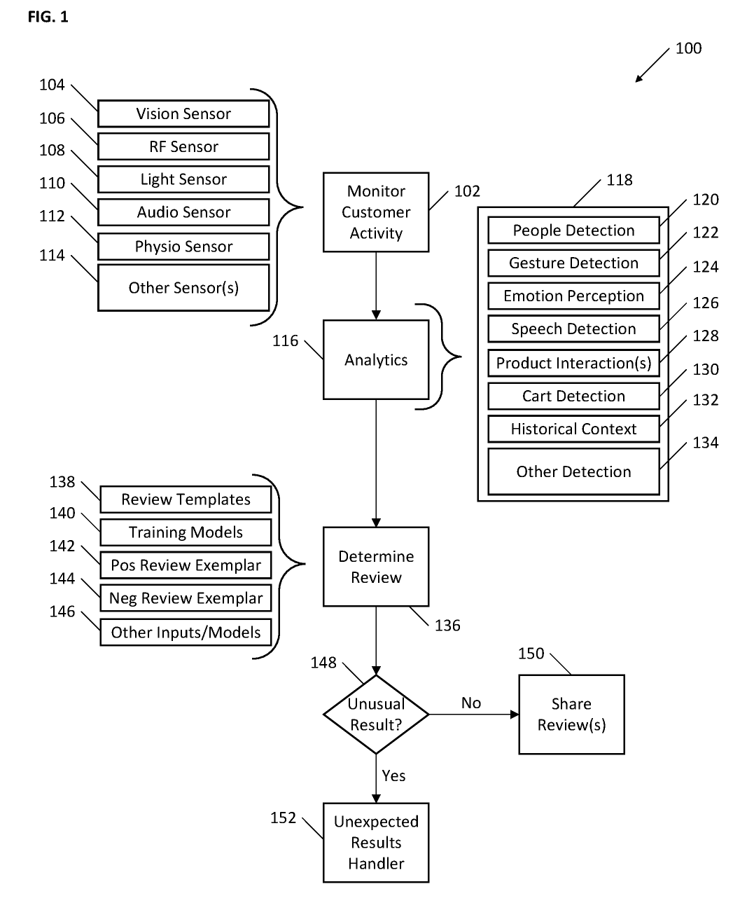

FIG. 1 illustrates an exemplary environment 100 illustrating an overview of tracking activity of a person, e.g. a customer, within an environment, e.g. a store allowing for a “brick-and-mortar,” e.g., a conventional retail sales environment, to access real-time customer reviews that may be at a granularity of a single consumer or presenting an aggregate of one or more customer inputs on one or more products and/or services. The customer input may be, for example, tracked data associated with customer-product interaction, customer emotion, customer movement/motion, etc. In embodiments, the customer input may be cast as a real time review that may be presented to one or more other customers.

This contrasts a typical consumer situation, in which conventional post-purchase customer reviews, or contemporaneous customer reviews, may be placed with an online platform such as a reviews website, mobile app, social media or by using pre-installed customer evaluation devices. See “HappyOrNot”, HappyOrNot Ltd., at Internet URL www.happy-or-not.com/en; “Feedback system for retail stores, supermarkets, malls & shops”, Zonka, at Internet URL www.zonkafeedback.com/retail-shopping-customer-feedback-system; “Do your customers love you?”, Client Heartbeat, at Internet URL www.clientheartbeat.com; or Amol S. Patwardhan and Dr. Gerald M. Knapp, “Multimodal Affect Analysis for Product Feedback Assessment”, IIE Annual Conference, Proceedings, Institute of Industrial Engineers, arXiv: 1705.02694. Although Patwardhan does provide for limited customer emotion analysis, no references are known which provide the disclosed combining emotional responses with customer interaction(s) with a product, nor dynamically creating sharable peer-to-peer reviews, or sharing reviews in real time in a variety of ways, e.g., within an environment such as a store, targeting specific other customer demographics, and/or to selected online resources, etc.

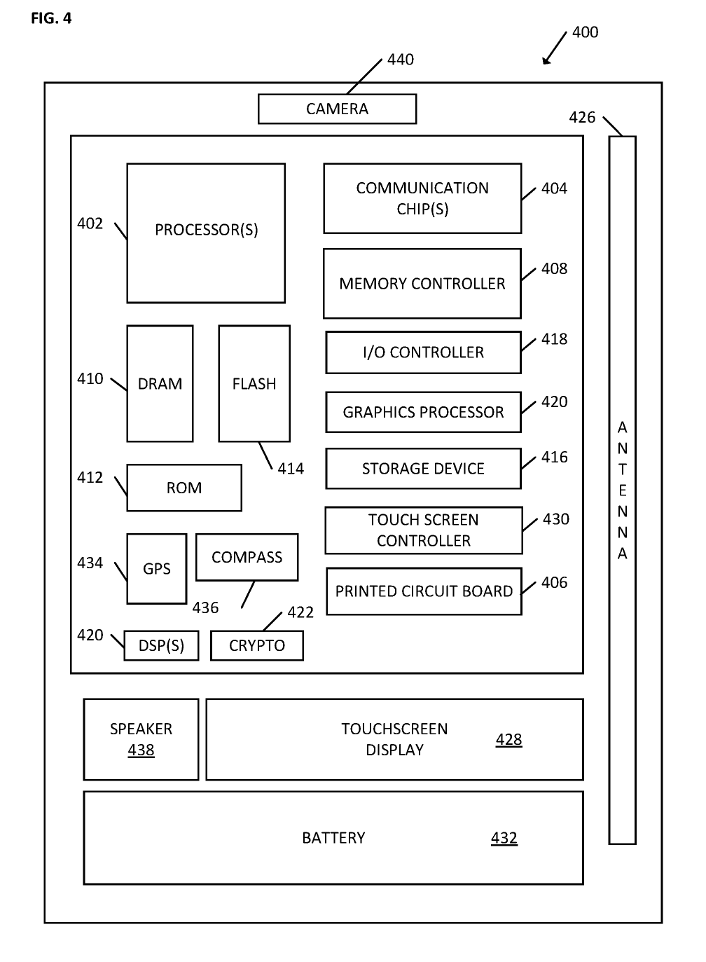

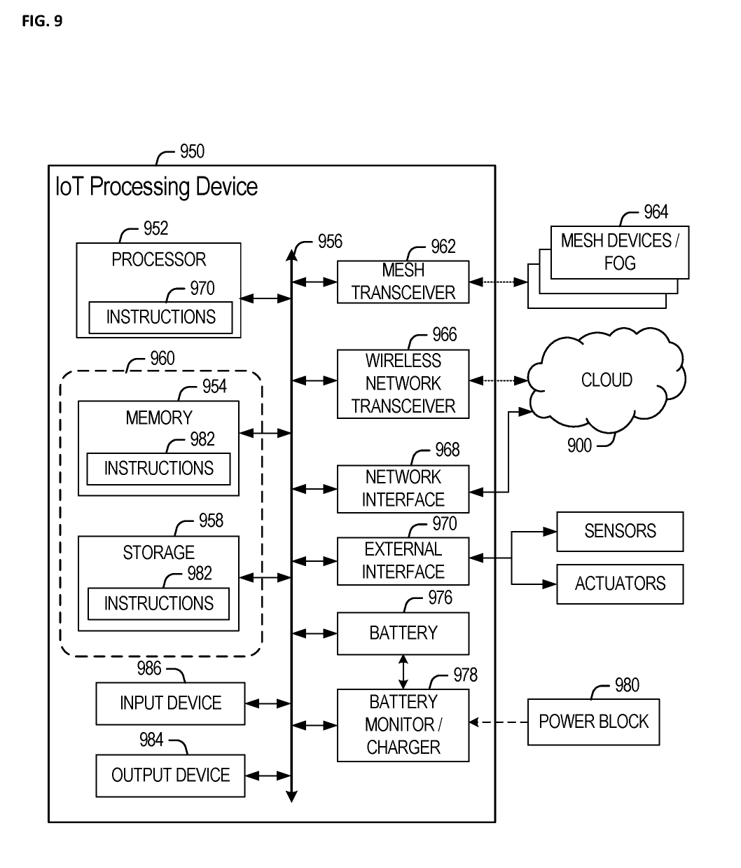

In one embodiment, real-time customer reviews in a store may be obtained by using a variety of sensors to monitor 102 customer interactions. It will be appreciated that sensors may employ a variety of local or longer-distance communications, such as those provided by Wireless Sensor Networks (WSNs), Near Field Communication (NFC), Wi-Fi, and/or other wireless technology discussed in more detail below with respect to, for example, FIGS. 4 and 9 and elsewhere. It will be appreciated many different kinds of sensors may be used to monitor a customer (or any person or animal performing any type of task or performance). In the illustrated embodiment the monitoring 102 may be performed with a vision sensor(s) 104 to watch customer movement and that may be fed into video analysis tools to identify characteristics and emotional content of a customer, such as through identification and interpretation of facial features (see, e.g., Internet URL azure. microsoft.com/en-us/services/cognitive-services/emotion. RF sensor(s) 106 (which may be any form of RF emitter, including, for example, Wi-Fi), may be used to reflect a signal off of a person and used to detect various physiological statuses such as heartrate, respiration or other body status and be interpreted to identify emotional state, monitor a person's movement, identify different people, determine physical characteristics/shape, and even operate through obstructions (see, e.g., Internet URL rfcapture.csail.mit.edu and news.mit.edu/2016/detecting-emotions-with-wireless-signals-0920). Gentiane presented an emotion recognition approach using gait data which highlights the feature vectors that characterize emotions (e.g., neutral, joy, anger, sadness and fear) based on analysis of the lower torso and variation of inclination of the trunk. See Gentiane et al., Recognizing Emotions Conveyed by Human Gait, International Journal of Social Robotics, Vol. 6, Issue 4, pp 621-632, 2014. See also, Mingmin Zhao et al., Emotion recognition using wireless signals, Proceedings of the 22nd Annual International Conference on Mobile Computing and Networking (MobiCom '16). ACM, New York, N.Y., USA, 95-108, at Internet URL doi.org/10.1145/2973750.2973762. Light sensor(s) 108, e.g., Visible Light Communication (VLC), may also be used to convey data while lighting an area in which a person is monitored. Audio sensor(s) 110 may also be used to listen to a person, and identify, among other characteristics of the person, apparent interest, disinterest, or emotional state (e.g., an excited utterance would suggest surprise, happiness, anger, etc. Physiological sensor(s) 112, including wearable sensors, may be used to detect heartrate, breathing, body movement, acceleration, blood pressure, Galvanic Skin Response (GSR) (which may be used to identify stress), may be used to monitor various states of a person from which emotional, mental, and other conditions of a person. It will be appreciated sensors 104-112 are presented for exemplary purposes, and other sensor(s) 114 may be used as well to assist with understanding the state and/or status of a person, such as a customer, and that these and/or other sensors not illustrated may be combined such as through sensor fusion to derive other information concerning a person.

In one embodiment, the sensor(s) 104-114 input(s) may be provided to one or more analytics 116 tools. It will be appreciated one facet of the present disclosure is to automatically derive customer reviews based on observation of customer interaction within an environment, such as in a physical (“brick and mortar”) store. A variety of “emotional” determination may be made to discern a likely relevant review from a particular person or persons looking at a product. For example, vision sensor 104 data may be interpreted by an analytics tool to identify, among other things, a person's location in relation to, for example, the store, product, store display, sales area, etc. Vision sensor data may be used to detect emotional state based at least in part on analyzing body language, gait, movement, facial expression, etc. For example, based at least in part on analyzing gait data highlighting feature vectors that characterize emotions, multiple different emotional states may be detected, e.g., neutral, joy, anger, sadness, and fear. For example, Gentiane shows Principal Component Analysis (PCA) feature vectors may be used to analyze the motion data captured from the lower torso and variation of inclination of the trunk.

Vision sensor data may also be used to detect apparent grouping with other people which may imply a condition for the person based in part on analysis of other group members. RF sensor(s) 106 or light sensor(s) 108 may be used to detect physiological conditions, e.g., heartrate, breathing rate, blood pressure, sweating, identity (even if obscured by walls), and the like, and this data may also be processed by the analytics tools to also identify emotional and other characteristics that may be associated with a person, e.g., a customer. It will be appreciated different sensor types may provide redundant detections, such as heartrate, and that may be used to validate one sensor readings against another sensor providing the same or similar data.

By receiving these and other sensor data, it will be appreciated sensor data may, individually or in combination, allow an analytics tools to directly or indirectly with analysis, determine various desirable features 118 within a particular environment, e.g., a store or area around a product in a store. For example, the sensor(s) data may be used to detect 120 people within the environment, detect 122 (and hence then classify) gestures, perceive 124 emotional context for a person, and the like. Multiple different sensors may be used to analyze a person and the various sensor data may be combined to make, for example, a likely determination of emotional state in a given context. It will be appreciated based on other analysis the emotional state may be attributed to various contexts and/or actions, such as monitoring state changes as a person moves through a store to get a sense of what things are of interest to a person based, for example, on gaze tracking, and/or gaze lingering, and/or picking up products, and/or repeat access to a product, and/or physiological data while handling a product, etc.). In addition, speech detection 126 may be used to identify oral outbursts (excited/happy utterances, angry tones, etc.) and speech transcription and analysis/data mining may be used to classify what was said to obtain additional context for what the person is thinking/feeling in a particular context, e.g., while engaged with a product. All of the various sensor and derivable context inputs may be analyzed to identify emotional context and other analytic results for a particular product, e.g., an item for sale or other aspect/location/display within a store.

In one embodiment, an item is considered to be of interest to a person if the item is placed in a shopping cart. While it is appreciated handling and associated emotional context may be indicative of some interest, in one embodiment, placement of an item in a shopping cart may be considered dispositive of interest. It will be appreciated sensors 104-114 may directly, or indirectly by way of analytics, detect 130 putting an item in the shopping cart. Analytics 116 associated with such placement, e.g., information derived from the sensors 104-114, may affect the nature of conclusions and/or reviews to be attributed to a person for an item. In addition, somewhat similar to how different web sites seek to track a person's travels and purchases on the Internet, a store or other entity may maintain a historical context 132 for a person. This may include not only include past purchases, but also associated emotional, physiological and other contexts derived about a person over multiple trips to a store or stores.

Historical context 132 may be used, at least in part, to determine a significance of putting an item into a cart. For example, if it is a first-time event, it may be significant. If it is an occurrence after a history of apparent lack of product interest, then something has changed, perhaps due to a change in opinion about a product after receiving other input, such as a real-time review(s) from other people/customer(s); in this context, and putting an item into the cart is likely significant. In contrast, if it is a routine purchase, cart placement might be given lesser or no value, and possibly not warrant preparing a dynamic review at all, allowing resources to be conserved by not analyzing that activity. It will be appreciated illustrated analytics 116 may provide other detection(s) 134 in addition to the illustrated exemplary detections 120-132 of people, gestures, emotions, speech, product interaction, cart placement, and historical context.

In one embodiment, results 120-134 from analytics 116, which may be based at least in part on inputs from sensors 104-114, describing customer-product responses, interactions, and other associated context, may be provided to a tool to determine 136 a review based on evaluation and/or classification of the analytics results. The review may be presented as a quantified customer review. In one embodiment, results are used to determine a star-rating or other type of quantified rating based on a desired metric or rating scheme. In one embodiment, ratings may be determined not only for a customer's interest in a particular product, but also for interest (or lack thereof) for any process, event, store display, store personnel interaction, branded shopping environment (such as an embedded store), etc. Once sensors and supporting structure (local and/or back-end data support) are in place, and able to monitor a person's activity in an environment such as a store, reviews may be determined and associated with the person for virtually any interaction between the person and things in an environment, including interactions between the person and a product. Anything a person may interact with may be tracked, analyzed and reported.

In one embodiment, reviews are determined 136 with a tool or tools that are provided analytics 116 data 120-134 along with other data to assist with automatic review determination and creation. For example, one or more review template(s) 138 may be provided to form the basic structure of a review. The template may be geared to a particular type of review being made, e.g., based on a particular type of product, service, etc., where portions of the review are filled in based on analytics. There may be multiple different templates based on the results present in the analytics. For example, a very happy customer may suggest using a template providing very positive language, whereas a customer that seemed calm but nonetheless buying a product might have a different template applied with language to suggest temperate enthusiasm yet support in the review. It will be appreciated tool(s) generating the review may use an artificial intelligence (AI) component, e.g., neural net, deep neural network, expert system, rules system, etc., that may be trained on a variety of training models 140 that may include, for example, review exemplars 142, 144 for different levels and types of like and/or dislike of things that may be reviewed, e.g., monitored interactions between a customer and products, processes, displays, other things/entities. It will be appreciated the foregoing are exemplary inputs to the review determination 136, and other 146 inputs and/or models may be provided to assist with determining an appropriate review that captures a particular circumstance and/or context for a person's, e.g., a customer's, experience.

Once a review is determined 136, it may be checked to determine if 148 an unusual result has been recorded. For example, in an environment that is monitoring multiple customers, it may be apparent one or more customers are having one or more analytics 116 results suggesting an aberrant result. For example, customers may have a typical range of physiological 112, audio 110, etc. sensor readings, and typical detected body (e.g., gesture 122) movement, but one customer might register unusually loud audio noises, overly fast heartrate, or exhibit wild gesticulations. This would suggest something is wrong, and may register as the customer being very angry, or scared, or even unusually happy. In any of these (or other aberrant) situations, such unexpected results may be passed on to a handler 142 which may, for example, notify a store employee to look into the situation. In addition, in will be appreciated determined 136 reviews, as well as other results that may be associated with a particular product, may be provided to the product manufacturer or other vendors to assist with improving product development. It will be appreciated tests for unusual results may be performed after analytics 116 and before determining 136 the review (not illustrated), or both before and after. An earlier (not illustrated) test may be performed to catch unusual analytics results, suggesting of, for example, extreme highs or lows in a customer's emotional context.

In the illustrated embodiment, performing the test if 148 an unusual result has been recorded allows for also checking whether the determined 136 review ends up being controversial. For example, a historical context may suggest a customer is historically happy or unhappy with a type of product and generating a review that is contrary to the typical result may warrant investigation. Similarly, if other customers are typically having reviews different from that determined for a current customer, that may also warrant investigation. A retailer may be informed when there are anomalous results from customers to allow immediate (if possible) handling of an issue within the environment and/or taking action for subsequent customer engagement to reduce negative impact from bad reviews. In the context of store sales, monitoring customers may provide data suggesting that relocating products within a store, or adjusting a price, etc. may help improve negative customer engagement.

If 148 the result is not unusual, then a determined 136 review may be shared. In one embodiment, the review is posted to various social media sites on behalf of the customer. The review may be automatically posted. In one embodiment, a person may opt-in to such postings. In another embodiment, signage on an environment indicates the presence of the monitoring and automatic review determinations for recognized people and/or people that later identify themselves to the environment (e.g., by way of using or signing up for a loyalty program). In another embodiment, the review may be pushed to a mobile app or mobile platform. In another embodiment, digital signage within the store and/or external to the store may be dynamically updated with positive reviews to attract attention to a store and/or specific products, promotions, sales, etc. In-store customer reviews become effective word-of-mouth recommendations to other customers who are currently shopping in a store, as well as recorded as reviews that may be posted publicly to draw other customers to the store.

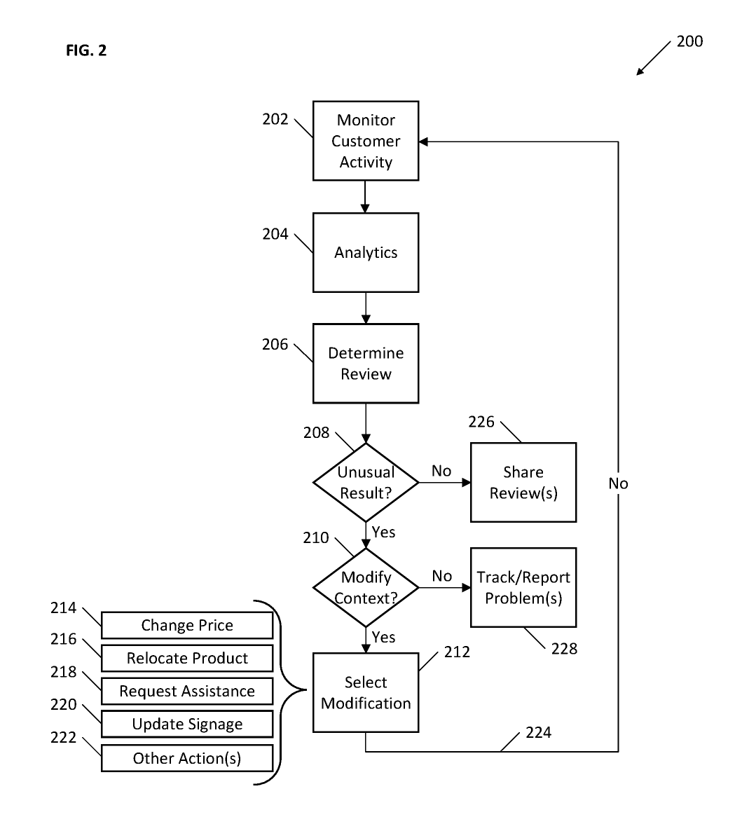

FIG. 2 illustrates an exemplary environment 200 illustrating adaptive feedback and updating within an environment responsive to tracking activity of a person. In the illustrated embodiment, shown are operations related to those discussed above with respect to FIG. 1, e.g. monitoring 202 a customer's activities within a store, applying analytics 204 to determine emotional and other contexts associated with the customer's interaction with products and/or other elements of the store, and determining 206 a review to be associated with the customer.

In this embodiment, a test may be performed, similar to FIG. 1, to determine if 208 there has been an unusual result. If yes, in one embodiment a test may be performed to determine if 210 there are any available operations/changes allowable to a context to address a perceived problem. If there are options, then a modification may be selected 212 and applied to the context. In this embodiment, the context is inclusive of all malleable aspect associated with a product, process or other entity/item with which a customer may interact. For example, changeable context items may include changing 214 a product price; relocating 216 a product's location in the store, either manually, or automatically such as in a smart store able to automatically relocate its content; requesting 218 assistance from store personnel, if, for example, a customer's analytics suggest confusion; update 220 signage such as on digital ink signage associated with and/or displayed alongside a product, where the update may include showing price adjustments, additional incentives, displaying product reviews (peer-to-peer or professional/commercial), and the like; or taking other action(s) that may be suggested by the circumstance, store, and/or vendor of a particular product.

After selecting 212 a modification, processing may loop 224 back to monitoring 202 the customer, performing updated analytics 204 to evaluate the result from making the modification, and determining 206 a review. If 208 post-modification there is no longer an unusual result, then in one embodiment a determined review may be shared 226. If 208 the result remains unusual, then if 210 there remain options available for modifying the context, this may be performed and processing loop 224. If no modification options remain then the problem(s) may be tracked 228 and/or reported by the store and/or a vendor/manufacturer.

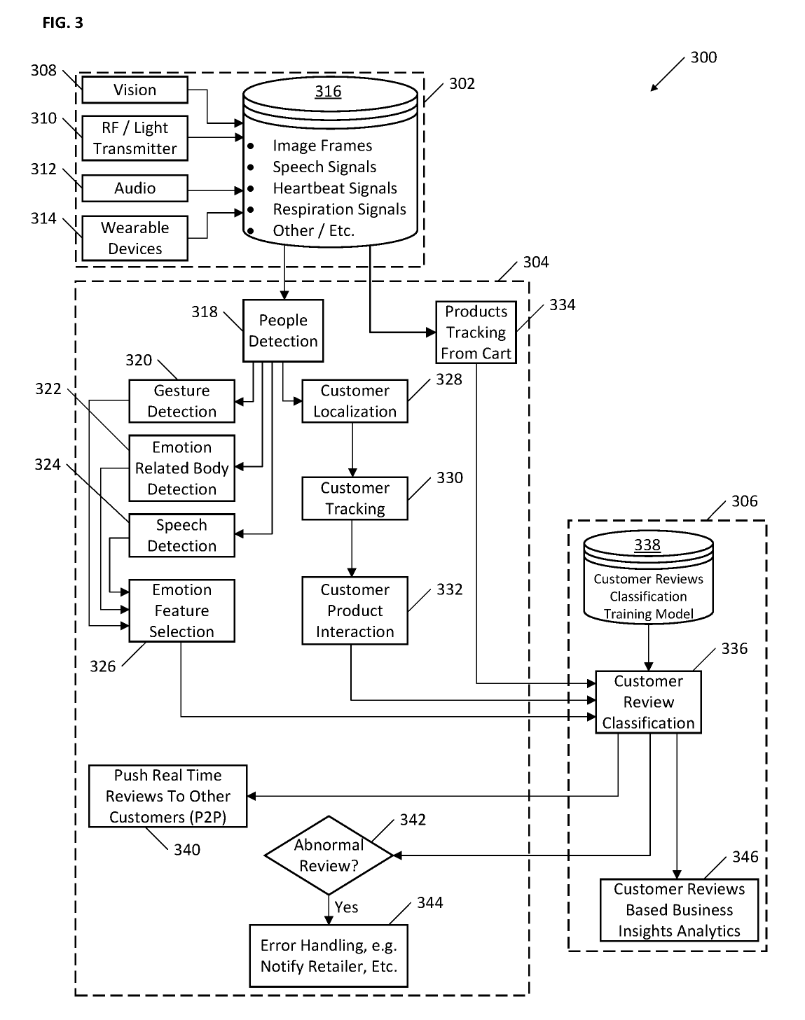

FIG. 3 illustrates an exemplary multi-modal framework 300 for tracking activity of a person in an environment with operations partitioned in accord with one embodiment of an Internet of Things (IoT) environment. Illustrated are three IoT environments 302-306.

The first environment 302 corresponds to edge devices and related edge activity. In this embodiment one or more edge gateway, e.g., a router, server, or other machine, may be used to collect various inputs from an environment, such as a store or other environment. Instead of potentially overwhelming a network and/or cloud system used to support the disclosed embodiments, instead a gateway may receive input such as streaming vision 308, RF signals or Visible Light Communication (VLC) signals 310, audio 312, or other sensors 314, such as wearable sensors, that can be used to detect emotions for a person, customer localization, customer-product interaction and in-cart product tracking. As discussed above with respect to FIG. 1 such sensor data may be used detect 316 emotion variations as well as customer-product engagement data during a person's interaction with an environment (e.g., products, shelves, ceiling, wall, store personnel, other people, etc.), such as during a visit to a store. See, for example, A. Jovicic, J. Li and T. Richardson, Visible light communication: opportunities, challenges and the path to market, in IEEE Communications Magazine, vol. 51, no. 12, pp. 26-32, December 2013. See also, H. S. Kim, D. R. Kim, S. H. Yang, Y. H. Son and S. K. Han, An Indoor Visible Light Communication Positioning System Using a RF Carrier Allocation Technique, in Journal of Lightwave Technology, vol. 31, no. 1, pp. 134-144, Jan. 1, 2013.

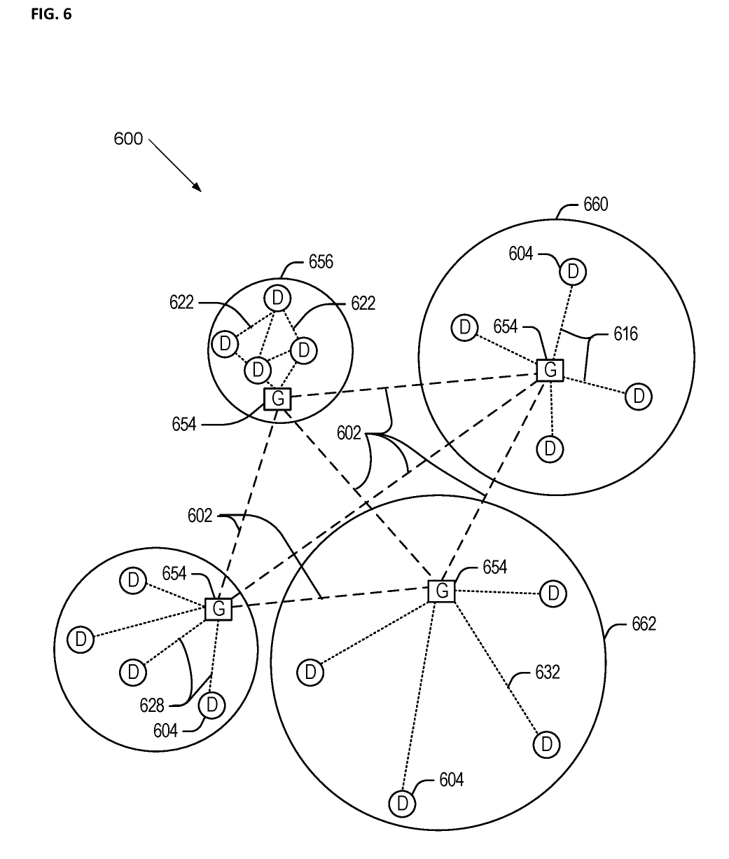

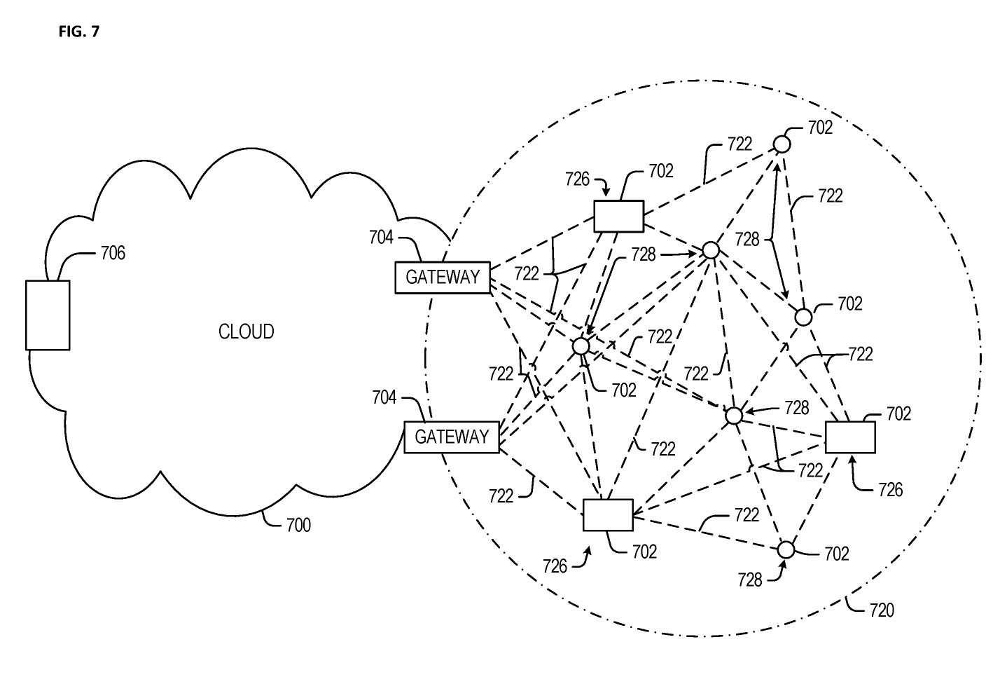

The second environment 304 corresponds to a fog system model providing support to the first environment and an architecture that distributes resources and services, such as computing, storage, control and networking between devices such as IoT devices, edge devices, or other devices/machines, and a network such as the Cloud and/or Internet. The fog environment is designed to support application domains and local intelligent services, such as the disclosed embodiments for monitoring and determining information and services related to a person's experience in a particular environment. For more information on fog, see, for example, the FIGS. 6 and 7 discussion. It will be appreciated by one skilled in the art that localized data processing may provide more responsive and/or valuable analysis in an environment. The fog environment may be designed for low-latency and be near the sensors of the first environment and may therefore respond directly in real or near real-time to input from sensors in the first environment 302. In one embodiment, the fog system may be is proximate to a network edge and local to its devices/sensors/etc.

The second environment 304 may contain, for example, emotion detection and activity detection for a person, e.g. a customer interacting with a store's products/environment. In one embodiment, based at least in part on information detected 318 about a person, a fog system includes at least a customer emotion related features integration/detection 322, 324 and extraction 326; a customer localization and customer interaction tracking 328-332; cart-related product tracking 334; and local support 340-344 for peer-to-peer product and other reviews from people in an environment, such as customers in a store, as well as person-to-employee and/or person-to-person interaction notification. It will be appreciated items 320-334 may focus on translating behaviors of a person, such as a customer's shopping behavior, into identification and classification of engagement with one or more of specific products, activities, entities, objects or anything else with which a person may tangibly and/or intangibly interact. See, e.g., FIG. 1 discussion above. Support 340-344 for reviews may, for example, focus on publishing real-time customer reviews to other customers in a store and provide alerts to employees and/or a vendor if any reviews crafted on behalf of a person suggest a need for immediate support, e.g., offer help to someone with a negative review, or offer thanks or loyalty rewards to customers with a positive experience.

The emotion related features 320-326 in this embodiment, may, for example, process raw input image frames;, speech signals; reflected RF (or other) signals; and/or heart beat signals, respiration signals and/or other physiological data received from the edge devices, such as sensors installed within an environment, e.g., installed within a store. See also the discussion with respect to the FIG. 1 embodiment. When using an edge and fog configuration, it will be appreciated sensor data may be pre-processed within the second environment, any may include data transformation, noise removal, data aggregation, sensor fusion, data derivation and/or extrapolation, etc. Sensor data may be used for person and/or group detection. Gesture 320, human emotion related body variation 322 (e.g. heartbeat, respiration) speech 324, etc. may be extracted 326 for a detected person or group. In one embodiment, significant and/or likely (based at least in part on known context data) emotion features are selected by feature extraction/machine learning, AI, or other heuristics, and sent to the cloud or other back-end support for further emotion classification and/or heat mapping.

In the illustrated embodiment, the customer localization and customer interaction tracking 328-332 is assumed for exemplary purposes to be determined based on using WiFi, VLC, or other emission, either alone or in combination with one or more other sensor such as accelerometers, or the like, and may be used to identify a person/customer. Technology, such as Intel®'s Precision Ubiquitous Location Sensing (PULS) indoor-positioning project (which recorded sub-meter resolution), using WiFi and accelerometers on smartphone, may be used. This contrasts results from typical sensor fusion and simple WiFi fingerprinting which lacks such accuracy. For more information, see U.S. patent Ser. No. 14/229,136 “Online adaptive fusion framework for mobile device indoor localization”. It will be appreciated PULS is presented for exemplary purposes, and other technology may be used.

In one embodiment vision, e.g., based on data output from one or more cameras or other sensors (that need not be video/visible light based) that can detect people and/or objects, may be used to pinpoint a person's proximity to an object of interest. For example, vision may be used to detect a shopper's proximity to products. Detection may be facilitated by, for example, marking items and/or zones/areas within a field of view for a camera(s) or sensor(s). It will be appreciated the markings may be visible to the eye, or non-visible, and may be technology including one or more of chemical, electromagnetic, magnetic, printed, labels, other demarcations or identifiable indicia, etc. When a person, such as a customer, moves around an environment and/or picks up an item, such as a product for sale, the person may detectably interfere with signal propagation paths between a sensor and a marking, and associated signal fluctuation(s) may be detected as variations in low-level signals, including disturbing phase, RSSI (received signal strength indicator), Doppler-shifted signal, scent, or other interference with a characteristic or data detection for a marking technology in use.

One example is detectable interference between a RFID reader and a RFID tag attached to an item. Such interference causes signal fluctuation, and in one embodiment, the intensity of signal variation may be determined based at least in part on how a person interacts with an item. In one embodiment, direct interaction (e.g., when a customer picks up a product) yields a stronger signal interference than the indirect interaction (e.g., a customer only walks around a specific shopping area without picking up anything). Similarly, behaviors exhibited by a person may produce distinct types of interference, such as between the exemplary RFID reader and RFID tag. These interferences may be analyzed to infer the customer shopping behaviors, including but not limiting to, a duration of standing/walking around an environment, such as a shopping area; a duration and timestamp of picking up various items, e.g., products for sale. The cart-related product tracking 334, and as discussed for the FIG. 1 embodiment, may be determined in a variety of ways. One technique such as the interference discussed above, alone or in combination with video sensor data analysis, allows identifying whether items or objects, such as products for sale, have been touched, picked up and/or placed in a cart for purchase.

The support 340-344 in the fog system of the second environment 304 for peer-to-peer product and other reviews from people in an environment, as well as person-to-employee and/or person-to-person interaction notification, may be supported through data received from the cloud or other Internet/remote network resources and provided to the on-premises fog system in the environment. In one embodiment, customer reviews classified from the cloud is fed back to the on premise fog system and used at least in part as real-time peer-to-peer reviews, such as real time customer reviews for products sold within the environment. In various embodiments the phrase “real-time” does not mean instant communication, rather it refers to communication that is relatively or substantially proximate in time to another activity. It will be appreciated real-time updated reviews and/or other information may be pushed 340 to other people in an environment, such as customers who are shopping in the same store, where the reviews and/or other information may be provided to mobile apps, digital signage, etc. associated with the recipients. Additionally, as with the FIG. 1 embodiment, in this embodiment, if 342 a person's review is outside expected parameters, a corresponding notification may be sent by an error handler 344 to, for example, a point of contact for an environment, such as a retailer's employee or representative in a sales context and/or to a vendor for an item or items having an abnormal review.

In one embodiment, the third environment 306 includes back-end support located on a remote (with respect to the second environment) network, such as in the cloud. The third environment provides support for generating customer reviews and business insights and analytics, and may include servers or other supporting machines and/or analytics services accessible by way of one or more communication pathways, including public or private cloud, the Internet, and/or other data pathway. In the illustrated embodiment, edge devices and/or sensors in a first environment 302 may be proximate to and communicating with a local or substantially local second environment 304 including a fog system, and the fog system may be configured to access resources of the third environment. In one embodiment, output from emotion feature selection 326, and/or customer product interaction 332, and/or cart related products tracking 334 are provided to a customer reviews classification tool 336. In one embodiment, the tool may operate based at least in part on classification training models determined from offline and/or not real-time data 338. In one embodiment the tool may be associated with business insights analytics 346 based at least in part on customer reviews which may be aggregated from multiple different environments, e.g., from multiple on premise fog systems in other environments like the second environment 304. Aggregated results may be analyzed and data mined to generate business and/or other analytics which may be used to make future decisions with respect to a particular environment.

In the FIG. 3 embodiment, customer reviews classification output may be provided as a real-time review 340 and used for error handling 342-344. In one embodiment, selected features are sent from the fog system 304 of the second environment to the cloud/back-end support of the third environment 306. Such features, e.g., emotion features, features that represent customer-product interaction, tracked items for a cart, etc. are input to the customer review classifier together with the pre-trained model to classify the customer feedback variation on the specific product. Likewise, the selected features are used for the continuous customer review classifier training and improvement. The resultant output from the customer review classifier may also be used to generate a heat map.

FIG. 4 illustrates an exemplary computer device 400 that may employ apparatuses and/or methods described herein, in accordance with various embodiments (e.g., to implement FIG. 1 items 102, 116, 136, 150, 152). As shown, computer device 400 may include a number of components, such as one or more processor(s) 402 (one shown) and at least one communication chip(s) 404. In various embodiments, the one or more processor(s) 402 each may include one or more processor cores. In various embodiments, the at least one communication chip 404 may be physically and electrically coupled to the one or more processor(s) 402. In further implementations, the communication chip(s) 404 may be part of the one or more processor(s) 402. In various embodiments, computer device 400 may include printed circuit board (PCB) 406. For these embodiments, the one or more processor(s) 402 and communication chip(s) 404 may be disposed thereon. In alternate embodiments, the various components may be coupled without the employment of PCB 406.

Depending on its applications, computer device 400 may include other components that may or may not be physically and electrically coupled to the PCB 406. These other components include, but are not limited to, memory controller 408, volatile memory (e.g., dynamic random access memory (DRAM) 410), non-volatile memory such as read only memory (ROM) 412, flash memory 414, storage device 416 (e.g., a hard-disk drive (HDD)), an I/O controller 418, a digital signal processor 420, a crypto processor 422, a graphics processor 424 (e.g., a graphics processing unit (GPU) or other circuitry for performing graphics), one or more antenna 426, a display which may be or work in conjunction with a touch screen display 428, a touch screen controller 430, a battery 432, an audio codec (not shown), a video codec (not shown), a positioning system such as a global positioning system (GPS) device 434 (it will be appreciated other location technology may be used), a compass 436, an accelerometer (not shown), a gyroscope (not shown), a speaker 438, a camera 440, and other mass storage devices (such as hard disk drive, a solid state drive, compact disk (CD), digital versatile disk (DVD)) (not shown), and so forth.

In some embodiments, the one or more processor(s) 402, flash memory 414, and/or storage device 416 may include associated firmware (not shown) storing programming instructions configured to enable computer device 400, in response to execution of the programming instructions by one or more processor(s) 402, to practice all or selected aspects of the methods described herein. In various embodiments, these aspects may additionally or alternatively be implemented using hardware separate from the one or more processor(s) 402, flash memory 414, or storage device 416. In one embodiment, memory, such as flash memory 414 or other memory in the computer device, is or may include a memory device that is a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAIVI) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In various embodiments, one or more components of the computer device 400 may implement an embodiment of the FIGS. 1-3 embodiments. Thus, for example, processor 402 could be in a machine implementing the FIG. customer review classification 336 communicating with memory 410 though memory controller 408. In some embodiments, I/O controller 418 may interface with one or more external devices to receive a data. Additionally, or alternatively, the external devices may be used to receive a data signal transmitted between components of the computer device 400.

The communication chip(s) 404 may enable wired and/or wireless communications for the transfer of data to and from the computer device 400. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip(s) may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device may include a plurality of communication chips 404. For instance, a first communication chip(s) may be dedicated to shorter range wireless communications such as Wi-Fi and Bluetooth, and a second communication chip 404 may be dedicated to longer range wireless communications such as GPS, EDGE, GPRS, CDMA, WiMAX, LTE, Ev-DO, and others.

The communication chip(s) may implement any number of standards, protocols, and/or technologies datacenters typically use, such as networking technology providing high-speed low latency communication. For example the communication chip(s) may support RoCE (Remote Direct Memory Access (RDMA) over Converged Ethernet), e.g., version 1 or 2, which is a routable protocol having efficient data transfers across a network, and is discussed for example at Internet URL RDMAconsortium.com. The chip(s) may support Fibre Channel over Ethernet (FCoE), iWARP, or other high-speed communication technology, see for example the OpenFabrics Enterprise Distribution (OFEDTM) documentation available at Internet URL OpenFabrics.org. It will be appreciated datacenter environments benefit from highly efficient networks, storage connectivity and scalability, e.g., Storage Area Networks (SANs), parallel computing using RDMA, Internet Wide Area Remote Protocol (iWARP), InfiniBand Architecture (IBA), and other such technology. Computer device 400 may support any of the infrastructures, protocols and technology identified here, and since new high-speed technology is always being implemented, it will be appreciated by one skilled in the art that the computer device is expected to support equivalents currently known or technology implemented in future.

In various implementations, the computer device 400 may be a laptop, a netbook, a notebook, an ultrabook, a smartphone, a computer tablet, a personal digital assistant (PDA), an ultra-mobile PC, a mobile phone, a desktop computer, a server, a printer, a scanner, a monitor, a set-top box, an entertainment control unit (e.g., a gaming console or automotive entertainment unit), a digital camera, an appliance, a portable music player, or a digital video recorder, or a transportation device (e.g., any motorized or manual device such as a bicycle, motorcycle, automobile, taxi, train, plane, etc.). In further implementations, the computer device 400 may be any other electronic device that processes data.

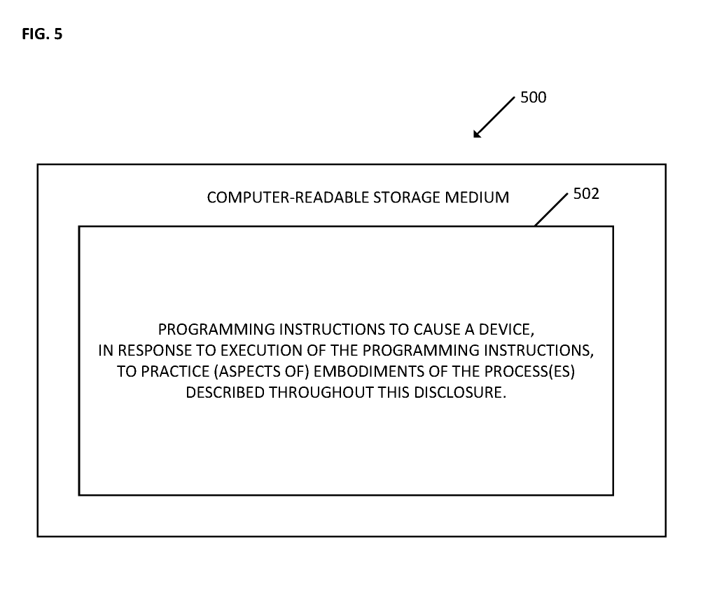

FIG. 5 illustrates an exemplary computer-accessible storage medium 500. The phrase “storage medium” is used herein to generally refer to any type of computer-accessible, computer-usable or computer-readable storage medium or combination of media. It will be appreciated a storage medium may be transitory, non-transitory or some combination of transitory and non-transitory media, and the storage medium may be suitable for use to store instructions that cause an apparatus, machine or other device, in response to execution of the instructions by the apparatus, to practice selected aspects of the present disclosure. As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. As shown, computer-accessible storage medium 500 may include a number of programming instructions 502. Programming instructions may be configured to enable a device, e.g., FIG. 4 computer device 400, in response to execution of the programming instructions, to implement (aspects of) a node executing internal software to manage monitoring sensors, recording events and if needed, updating an output such as a display to alter an initial plan for the node. The programming instructions may be used to operate other devices disclosed herein such as with respect to the disclosed embodiments for FIGS. 1-3. In alternate embodiments, programming instructions may be disposed on multiple computer-readable transitory and/or non-transitory storage media. In other embodiments, programming instructions may be disposed on computer-readable storage media and/or computer-accessible media, such as, signals.

Any combination of one or more storage medium may be utilized. The storage medium may be, for example but not limited to, an electronic, magnetic, optical, electromagnetic, infrared, or semiconductor system, apparatus, device, or propagation medium. More specific examples (a non-exhaustive list) of the storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a storage medium may be any medium that can contain, store, communicate, propagate, or transport the program for use by or in connection with the instruction execution system, apparatus, or device. The computer-accessible storage medium may include a propagated data signal with the computer-usable program code embodied therewith, either in baseband or as part of a carrier wave. The program code may be transmitted using any appropriate medium, including but not limited to wireless, wireline, optical fiber cable, RF, etc.

Computer-usable program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. It will be appreciated program code may operate as a distributed task operating on multiple machines cooperatively working to perform program code. In various embodiments, a remote computer may be connected to the user's computer through any type of network, including a local area network (LAN) or a wide area network (WAN), or the connection may be made to an external computer (for example, through the Internet using an Internet Service Provider). Cooperative program execution may be for a fee based on a commercial transaction, such as a negotiated rate (offer/accept) arrangement, established and/or customary rates, and may include micropayments between device(s) cooperatively executing the program or storing and/or managing associated data.

These computer program instructions may be stored in a storage medium that can direct a computer or other programmable data processing apparatus to function in a particular manner, such that the instructions stored in the storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

FIG. 6 illustrates an example domain topology 600 for respective internet-of-things (IoT) networks coupled through links to respective gateways. The Internet of Things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

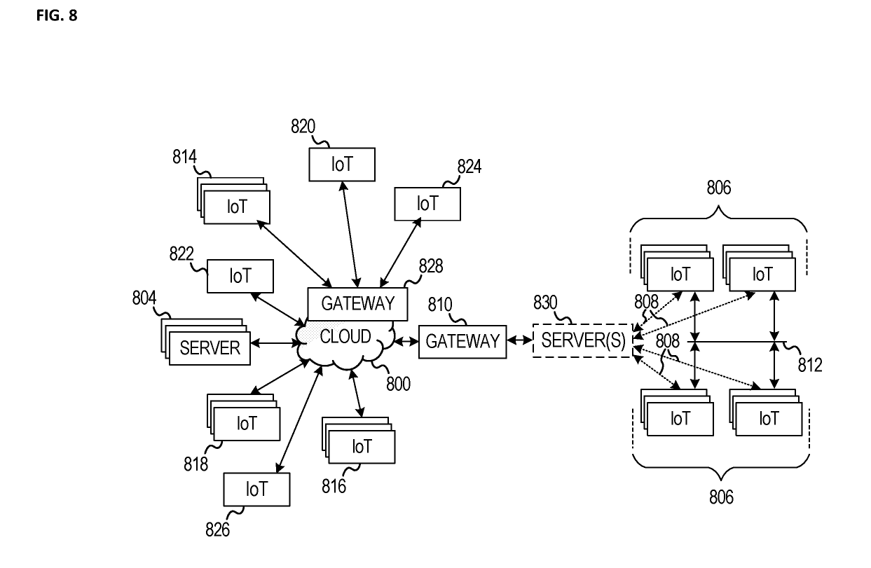

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 6 and 8, present a number of new challenges in a heterogeneous network of connectivity comprising a combination of wired and wireless technologies.

FIG. 6 specifically provides a simplified drawing of a domain topology that may be used for a number of internet-of-things (IoT) networks comprising IoT devices 604, with the IoT networks 656, 658, 660, 662, coupled through backbone links 602 to respective gateways 654. For example, a number of IoT devices 604 may communicate with a gateway 654, and with each other through the gateway 654. To simplify the drawing, not every IoT device 604, or communications link (e.g., link 616, 622, 628, or 632) is labeled. The backbone links 602 may include any number of wired or wireless technologies, including optical networks, and may be part of a local area network (LAN), a wide area network (WAN), or the Internet. Additionally, such communication links facilitate optical signal paths among both IoT devices 604 and gateways 654, including the use of MUXing/deMUXing components that facilitate interconnection of the various devices.

The network topology may include any number of types of IoT networks, such as a mesh network provided with the network 656 using Bluetooth low energy (BLE) links 622. Other types of IoT networks that may be present include a wireless local area network (WLAN) network 658 used to communicate with IoT devices 604 through IEEE 802.8 (Wi-Fi®) links 628, a cellular network 660 used to communicate with IoT devices 604 through an LTE/LTE-A (4G) or 5G cellular network, and a low-power wide area (LPWA) network 662, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 604, such as over the backbone links 602, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 656, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 658, for instance, may use systems that perform standards conversion to provide multi-standard connectivity, enabling IoT devices 604 using different protocols to communicate. Further systems may provide seamless interconnectivity across a multi-standard infrastructure comprising visible Internet resources and hidden Internet resources.

Communications in the cellular network 660, for instance, may be enhanced by systems that offload data, extend communications to more remote devices, or both. The LPWA network 662 may include systems that perform non-Internet protocol (IP) to IP interconnections, addressing, and routing. Further, each of the IoT devices 604 may include the appropriate transceiver for wide area communications with that device. Further, each IoT device 604 may include other transceivers for communications using additional protocols and frequencies. This is discussed further with respect to the communication environment and hardware of an IoT processing device depicted in other illustrated embodiments.

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 7 below.

FIG. 7 illustrates a cloud computing network in communication with a mesh network of IoT devices (devices 702) operating as a fog device at the edge of the cloud computing network. The mesh network of IoT devices may be termed a fog 720, operating at the edge of the cloud 700. To simplify the diagram, not every IoT device 702 is labeled.

The fog 720 may be considered to be a massively interconnected network wherein a number of IoT devices 702 are in communications with each other, for example, by radio links 722. As an example, this interconnected network may be facilitated using an interconnect specification released by the Open Connectivity FoundationTM (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 702 are shown in this example, gateways 704, data aggregators 726, and sensors 728, although any combinations of IoT devices 702 and functionality may be used. The gateways 704 may be edge devices that provide communications between the cloud 700 and the fog 720, and may also provide the backend process function for data obtained from sensors 728, such as motion data, flow data, temperature data, and the like. The data aggregators 726 may collect data from any number of the sensors 728, and perform the back end processing function for the analysis. The results, raw data, or both may be passed along to the cloud 700 through the gateways 704. The sensors 728 may be full IoT devices 702, for example, capable of both collecting data and processing the data. In some cases, the sensors 728 may be more limited in functionality, for example, collecting the data and allowing the data aggregators 726 or gateways 704 to process the data.

Communications from any IoT device 702 may be passed along a convenient path (e.g., a most convenient path) between any of the IoT devices 702 to reach the gateways 704. In these networks, the number of interconnections provide substantial redundancy, allowing communications to be maintained, even with the loss of a number of IoT devices 702. Further, the use of a mesh network may allow IoT devices 702 that are very low power or located at a distance from infrastructure to be used, as the range to connect to another IoT device 702 may be much less than the range to connect to the gateways 704.

The fog 720 provided from these IoT devices 702 may be presented to devices in the cloud 700, such as a server 706, as a single device located at the edge of the cloud 700, e.g., a fog device. In this example, the alerts coming from the fog device may be sent without being identified as coming from a specific IoT device 702 within the fog 720. In this fashion, the fog 720 may be considered a distributed platform that provides computing and storage resources to perform processing or data-intensive tasks such as data analytics, data aggregation, and machine-learning, among others.

In some examples, the IoT devices 702 may be configured using an imperative programming style, e.g., with each IoT device 702 having a specific function and communication partners. However, the IoT devices 702 forming the fog device may be configured in a declarative programming style, allowing the IoT devices 702 to reconfigure their operations and communications, such as to determine needed resources in response to conditions, queries, and device failures. As an example, a query from a user located at a server 706 about the operations of a subset of equipment monitored by the IoT devices 702 may result in the fog 720 device selecting the IoT devices 702, such as particular sensors 728, needed to answer the query. The data from these sensors 728 may then be aggregated and analyzed by any combination of the sensors 728, data aggregators 726, or gateways 704, before being sent on by the fog 720 device to the server 706 to answer the query. In this example, IoT devices 702 in the fog 720 may select the sensors 728 used based on the query, such as adding data from flow sensors or temperature sensors. Further, if some of the IoT devices 702 are not operational, other IoT devices 702 in the fog 720 device may provide analogous data, if available.

In other examples, the operations and functionality described above may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 8 illustrates a drawing of a cloud computing network, or cloud 800, in communication with a number of Internet of Things (IoT) devices. The cloud 800 may represent the Internet, or may be a local area network (LAN), or a wide area network (WAN), such as a proprietary network for a company. The IoT devices may include any number of different types of devices, grouped in various combinations. For example, a traffic control group 806 may include IoT devices along streets in a city. These IoT devices may include stoplights, traffic flow monitors, cameras, weather sensors, and the like. The traffic control group 806, or other subgroups, may be in communication with the cloud 800 through wired or wireless links 808, such as LPWA links, optical links, and the like. Further, a wired or wireless sub-network 812 may allow the IoT devices to communicate with each other, such as through a local area network, a wireless local area network, and the like. The IoT devices may use another device, such as a gateway 810 or 828 to communicate with remote locations such as the cloud 800; the IoT devices may also use one or more servers 830 to facilitate communication with the cloud 800 or with the gateway 810. For example, the one or more servers 830 may operate as an intermediate network node to support a local edge cloud or fog implementation among a local area network. Further, the gateway 828 that is depicted may operate in a cloud-to-gateway-to-many edge devices configuration, such as with the various IoT devices 814, 820, 824 being constrained or dynamic to an assignment and use of resources in the cloud 800.

Other example groups of IoT devices may include remote weather stations 814, local information terminals 816, alarm systems 818, automated teller machines 820, alarm panels 822, or moving vehicles, such as emergency vehicles 824 or other vehicles 826, among many others. Each of these IoT devices may be in communication with other IoT devices, with servers 804, with another IoT fog device or system (not shown, but depicted in FIG. 7), or a combination therein. The groups of IoT devices may be deployed in various residential, commercial, and industrial settings (including in both private or public environments).

As can be seen from FIG. 8, a large number of IoT devices may be communicating through the cloud 800. This may allow different IoT devices to request or provide information to other devices autonomously. For example, a group of IoT devices (e.g., the traffic control group 806) may request a current weather forecast from a group of remote weather stations 814, which may provide the forecast without human intervention. Further, an emergency vehicle 824 may be alerted by an automated teller machine 820 that a burglary is in progress. As the emergency vehicle 824 proceeds towards the automated teller machine 820, it may access the traffic control group 806 to request clearance to the location, for example, by lights turning red to block cross traffic at an intersection in sufficient time for the emergency vehicle 824 to have unimpeded access to the intersection.

Clusters of IoT devices, such as the remote weather stations 814 or the traffic control group 806, may be equipped to communicate with other IoT devices as well as with the cloud 800. This may allow the IoT devices to form an ad-hoc network between the devices, allowing them to function as a single device, which may be termed a fog device or system (e.g., as described above with reference to FIG. 7).

FIG. 9 is a block diagram of an example of components that may be present in an IoT device 950 for implementing the techniques described herein. The IoT device 950 may include any combinations of the components shown in the example or referenced in the disclosure above. The components may be implemented as ICs, portions thereof, discrete electronic devices, or other modules, logic, hardware, software, firmware, or a combination thereof adapted in the IoT device 950, or as components otherwise incorporated within a chassis of a larger system. Additionally, the block diagram of FIG. 9 is intended to depict a high-level view of components of the IoT device 950. However, some of the components shown may be omitted, additional components may be present, and different arrangement of the components shown may occur in other implementations.

The IoT device 950 may include a processor 952, which may be a microprocessor, a multi-core processor, a multithreaded processor, an ultra-low voltage processor, an embedded processor, or other known processing element. The processor 952 may be a part of a system on a chip (SoC) in which the processor 952 and other components are formed into a single integrated circuit, or a single package, such as the Edison™ or Galileo™ SoC boards from Intel. As an example, the processor 952 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 952 may communicate with a system memory 954 over an interconnect 956 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 958 may also couple to the processor 952 via the interconnect 956. In an example the storage 958 may be implemented via a solid state disk drive (SSDD). Other devices that may be used for the storage 958 include flash memory cards, such as SD cards, microSD cards, xD picture cards, and the like, and USB flash drives. In low power implementations, the storage 958 may be on-die memory or registers associated with the processor 952. However, in some examples, the storage 958 may be implemented using a micro hard disk drive (HDD). Further, any number of new technologies may be used for the storage 958 in addition to, or instead of, the technologies described, such resistance change memories, phase change memories, holographic memories, or chemical memories, among others.

The components may communicate over the interconnect 956. The interconnect 956 may include any number of technologies, including industry standard architecture (ISA), extended ISA (EISA), peripheral component interconnect (PCI), peripheral component interconnect extended (PCIx), PCI express (PCIe), or any number of other technologies. The interconnect 956 may be a proprietary bus, for example, used in a SoC based system. Other bus systems may be included, such as an I2C interface, an SPI interface, point to point interfaces, and a power bus, among others.

The interconnect 956 may couple the processor 952 to a mesh transceiver 962, for communications with other mesh devices 964. The mesh transceiver 962 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 964. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 962 may communicate using multiple standards or radios for communications at different range. For example, the IoT device 950 may communicate with close devices, e.g., within about 10 meters, using a local transceiver based on BLE, or another low power radio, to save power. More distant mesh devices 964, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 966 may be included to communicate with devices or services in the cloud 900 via local or wide area network protocols. The wireless network transceiver 966 may be a LPWA transceiver that follows the IEEE 802.15.4, or IEEE 802.15.4g standards, among others. The IoT device 950 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 962 and wireless network transceiver 966, as described herein. For example, the radio transceivers 962 and 966 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 962 and 966 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 966, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 968 may be included to provide a wired communication to the cloud 900 or to other devices, such as the mesh devices 964. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional MC 968 may be included to allow connect to a second network, for example, a NIC 968 providing communications to the cloud over Ethernet, and a second NIC 968 providing communications to other devices over another type of network.

The interconnect 956 may couple the processor 952 to an external interface 970 that is used to connect external devices or subsystems. The external devices may include sensors 972, such as accelerometers, level sensors, flow sensors, optical light sensors, camera sensors, temperature sensors, a global positioning system (GPS) sensors, pressure sensors, barometric pressure sensors, and the like. The external interface 970 further may be used to connect the IoT device 950 to actuators 974, such as power switches, valve actuators, an audible sound generator, a visual warning device, and the like.

In some optional examples, various input/output (I/O) devices may be present within, or connected to, the IoT device 950. For example, a display or other output device 984 may be included to show information, such as sensor readings or actuator position. An input device 986, such as a touch screen or keypad may be included to accept input. An output device 984 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 950.

A battery 976 may power the IoT device 950, although in examples in which the IoT device 950 is mounted in a fixed location, it may have a power supply coupled to an electrical grid. The battery 976 may be a lithium ion battery, or a metal-air battery, such as a zinc-air battery, an aluminum-air battery, a lithium-air battery, and the like.

A battery monitor/charger 978 may be included in the IoT device 950 to track the state of charge (SoCh) of the battery 976. The battery monitor/charger 978 may be used to monitor other parameters of the battery 976 to provide failure predictions, such as the state of health (SoH) and the state of function (SoF) of the battery 976. The battery monitor/charger 978 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 978 may communicate the information on the battery 976 to the processor 952 over the interconnect 956. The battery monitor/charger 978 may also include an analog-to-digital (ADC) convertor that allows the processor 952 to monitor directly the voltage of the battery 976 or the current flow from the battery 976. The battery parameters may be used to determine actions that the IoT device 950 may perform, such as transmission frequency, mesh network operation, sensing frequency, and the like.

A power block 980, or other power supply coupled to a grid, may be coupled with the battery monitor/charger 978 to charge the battery 976. In some examples, the power block 980 may be replaced with a wireless power receiver to obtain the power wirelessly, for example, through a loop antenna in the IoT device 950. A wireless battery charging circuit, such as an LTC4020 chip from Linear Technologies of Milpitas, Calif., among others, may be included in the battery monitor/charger 978. The specific charging circuits chosen depend on the size of the battery 976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 958 may include instructions 982 in the form of software, firmware, or hardware commands to implement the techniques described herein. Although such instructions 982 are shown as code blocks included in the memory 954 and the storage 958, it may be understood that any of the code blocks may be replaced with hardwired circuits, for example, built into an application specific integrated circuit (ASIC).

In an example, the instructions 982 provided via the memory 954, the storage 958, or the processor 952 may be embodied as a non-transitory, machine readable medium 960 including code to direct the processor 952 to perform electronic operations in the IoT device 950. The processor 952 may access the non-transitory, machine readable medium 960 over the interconnect 956. For instance, the non-transitory, machine readable medium 960 may be embodied by devices described for the storage 958 of FIG. 9 or may include specific storage units such as optical disks, flash drives, or any number of other hardware devices. The non-transitory, machine readable medium 960 may include instructions to direct the processor 952 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions. Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 may be a system in which a first environment including one or more sensor to monitor a person associated with a second environment substantially-local to the first environment, the second environment including one or more analytics tool to analyze the person and communicate with a third environment including one or more back-end tool to dynamically generate reviews to be associated with the person, the system comprising: the sensor to perform a selected one or more of record of the person: motion, physiological data, or audio; the analytics tool to perform, with respect to the person, a selected one or more of: determine a motion of the person, or determine an emotion associated with the person; and the back-end tool to provide to at least the analytics tool, with respect to the person, a dynamically generated review to be associated with the person based at least in part on data from the analytics tool.

Example 2 may be example 1, further comprising the second environment including a handler for providing a response to the review.

Example 3 may be any of example 1-2, in which there are at least two sensors, the system further comprising the analytics tool to use sensor fusion of the two sensors to establish a virtual sensor to monitor the person.

Example 4 may be any of example 1-3, wherein the record motion of the person may be a selected one or more of: visually record, record a reflection if emit a RF signal, record a reflection if emit a VLC light.

Example 5 may be any of example 1-4, further comprising the analytics tool to perform a selected one or more of a detection of: people, gesture, emotion, or speech.

Example 6 may be any of example 1-5, further comprising the analytics tool to perform a selected one or more of a detection of: product interaction, cart placement, historical comparison, or purchase.

Example 7 may be any of example 1-6, further comprising the back end tool to generate the review based at least in part on: a review template, or a training model.

Example 8 may be example 7 wherein the review template is selected from at least a first template and a second template, the first template associated with a positive emotion detection by the analytics tool, and the second template associated with a negative emotion detection by the analytics tool.

Example 9 may be any of example 1-8 further comprising the second environment including a sharing tool to share the review with at least a second person associated with the second environment.

Example 10 may be example 9, further comprising: the second environment is associated with a brick-and-mortar store; the person and the second person are shoppers within the store; and the sharing tool pushes the review to the second person.

Example 11 may be a method in which a first environment including one or more sensor to monitor a person associated with a second environment substantially-local to the first environment, the second environment including one or more analytics tool to analyze the person and communicate with a third environment including one or more back-end tool to dynamically generate reviews to be associated with the person, the method comprising: providing sensor data from the sensor to the analytics tool, the sensor data including a selected one or more of a recording of the person interacting with a portion of the second environment, the recording including: motion, physiological data, or audio; providing analytics data from the analytics tool to the back-end tool, the analytics data corresponding the recording and including one or more of the analytics tool determining: motion of the person, or an emotion associated with the person; determining a review to be associated with the person, the review corresponding at least in part to the analytics data and the review including a rating; and determining if the rating corresponds to a usual result or an unusual result.

Example 12 may be example 11 wherein the determining the review is dynamically generated in substantially real-time to the providing analytics data.

Example 13 may be example 12, wherein if the usual result, the method further comprising pushing the review to a second person in the second environment.

Example 14 may be example 13, wherein the person and the second person are shopping in a store, and the pushing the review includes a selected one or more of: updating a sign associated with the portion of the second environment, or providing an announcement to a personal device associated with the second person.

Example 15 may be example 14, wherein the portion of the second environment is a selected one of: an item for sale in the store, an employee of the store, a representative associated with the item for sale

Example 16 may be any of examples 11-15, wherein if the unusual result, the method further comprising modifying a context associated with the item.

Example 17 may be any of examples 11-16, in which there are at least two sensors, the method further comprising the analytics tool to use sensor fusion of the two sensors to establish a virtual sensor to monitor the person.

Example 18 may be any of examples 11-17, wherein if recording motion of the person the recording may be a selected one or more of: visually record, record a reflection if emit a RF signal, record a reflection if emit a VLC light.

Example 19 may be any of examples 11-18, further comprising the analytics tool determining a selected one or more of a detection of: people, gesture, emotion, speech, product interaction, cart placement, historical comparison, or purchase.

Example 20 may be any of examples 11-19, further comprising the determining the review based at least in part on a review template, or a training model; wherein the review template is selected from at least a first template and a second template, the first template associated with a positive emotion detection by the analytics tool, and the second template associated with a negative emotion detection by the analytics tool.

Example 21 may be one or more non-transitory computer-readable media associated with a first environment including one or more sensor to monitor a person associated with a second environment substantially-local to the first environment, the second environment including one or more analytics tool to analyze the person and communicate with a third environment including one or more back-end tool to dynamically generate reviews to be associated with the person, the media having instructions to provide for: providing sensor data from the sensor to the analytics tool, the sensor data including a selected one or more of a recording of the person interacting with a portion of the second environment, the recording including: motion, physiological data, or audio; providing analytics data from the analytics tool to the back-end tool, the analytics data corresponding the recording and including one or more of the analytics tool determining: motion of the person, or an emotion associated with the person; determining a review to be associated with the person, the review corresponding at least in part to the analytics data and the review including a rating; and determining if the rating corresponds to a usual result or an unusual result, and if the usual result, pushing the review to a second person in the second environment.

Example 22 may be example 21 further including instructions to provide for, if the unusual result, modifying a context associated with the item.

Example 23 may be any of examples 21-22, in which there are at least two sensors in the first environment, the media further including instructions to provide for using sensor fusion of the two sensors to establish a virtual sensor to monitor the person.

Example 24 may be any of examples 21-23 further providing instructions for the analytics tool determining a selected one or more of a detection of: people, gesture, emotion, speech, product interaction, cart placement, historical comparison, or purchase.

Example 25 may be and of examples 21-24 in which the instructions for recording motion of the person including further instructions providing for emitting a selected one or more of: visually record, record a reflection if emit a RF signal, record a reflection if emit a VLC light.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A system in which a first environment including one or more sensor to monitor a person associated with a second environment substantially-local to the first environment, the second environment including one or more analytics tool to analyze the person and communicate with a third environment including one or more back-end tool to dynamically generate reviews to be associated with the person, the system comprising:
the sensor to perform a selected one or more of record of the person: motion, physiological data, or audio;
the analytics tool to perform, with respect to the person, a selected one or more of: determine a motion of the person, or determine an emotion associated with the person; and
the back-end tool to provide to at least the analytics tool, with respect to the person, a dynamically generated review to be associated with the person based at least in part on data from the analytics tool.

2. The system of claim 1 further comprising the second environment including a handler for providing a response to the review.

3. The system of claim 1, in which there are at least two sensors, the system further comprising the analytics tool to use sensor fusion of the two sensors to establish a virtual sensor to monitor the person.

4. The system of claim 1, wherein the record motion of the person may be a selected one or more of: visually record, record a reflection if emit a RF signal, record a reflection if emit a VLC light.

5. The system of claim 1, further comprising the analytics tool to perform a selected one or more of a detection of: people, gesture, emotion, or speech.

6. The system of claim 1, further comprising the analytics tool to perform a selected one or more of a detection of: product interaction, cart placement, historical comparison, or purchase.

7. The system of claim 1, further comprising the back end tool to generate the review based at least in part on: a review template, or a training model.

8. The system of claim 7 wherein the review template is selected from at least a first template and a second template, the first template associated with a positive emotion detection by the analytics tool, and the second template associated with a negative emotion detection by the analytics tool.

9. The system of claim 1 further comprising the second environment including a sharing tool to share the review with at least a second person associated with the second environment.

10. The system of claim 9, further comprising:
the second environment is associated with a brick-and-mortar store;
the person and the second person are shoppers within the store; and
the sharing tool pushes the review to the second person;
wherein shoppers in the store consent to share and/or receive the review.

11. A method in which a first environment including one or more sensor to monitor a person associated with a second environment substantially-local to the first environment, the second environment including one or more analytics tool to analyze the person and communicate with a third environment including one or more back-end tool to dynamically generate reviews to be associated with the person, the method comprising:
providing sensor data from the sensor to the analytics tool, the sensor data including a selected one or more of a recording of the person interacting with a portion of the second environment, the recording including: motion, physiological data, or audio;
providing analytics data from the analytics tool to the back-end tool, the analytics data corresponding the recording and including one or more of the analytics tool determining: motion of the person, or an emotion associated with the person;
determining a review to be associated with the person, the review corresponding at least in part to the analytics data and the review including a rating; and
determining if the rating corresponds to a usual result or an unusual result.

12. The method of claim 11 wherein the determining the review is dynamically generated in substantially real-time to the providing analytics data.

13. The method of claim 12, wherein if the usual result, the method further comprising pushing the review to a second person in the second environment.

14. The method of claim 13, wherein the person and the second person are shopping in a store, and the pushing the review includes a selected one or more of: updating a sign associated with the portion of the second environment, or providing an announcement to a personal device associated with the second person.

15. The method of claim 14, wherein the portion of the second environment is a selected one of: an item for sale in the store, an employee of the store, a representative associated with the item for sale

16. The method of claim 11, wherein if the unusual result, the method further comprising modifying a context associated with the item.

17. The method of claim 11, in which there are at least two sensors, the method further comprising the analytics tool to use sensor fusion of the two sensors to establish a virtual sensor to monitor the person.

18. The method of claim 11, wherein if recording motion of the person the recording may be a selected one or more of: visually record, record a reflection if emit a RF signal, record a reflection if emit a VLC light.

19. The method of claim 11, further comprising the analytics tool determining a selected one or more of a detection of: people, gesture, emotion, speech, product interaction, cart placement, historical comparison, or purchase.

20. The method of claim 11, further comprising the determining the review based at least in part on a review template, or a training model;
wherein the review template is selected from at least a first template and a second template, the first template associated with a positive emotion detection by the analytics tool, and the second template associated with a negative emotion detection by the analytics tool.

21. One or more non-transitory computer-readable media associated with a first environment including one or more sensor to monitor a person associated with a second environment substantially-local to the first environment, the second environment including one or more analytics tool to analyze the person and communicate with a third environment including one or more back-end tool to dynamically generate reviews to be associated with the person, the media having instructions to provide for:
providing sensor data from the sensor to the analytics tool, the sensor data including a selected one or more of a recording of the person interacting with a portion of the second environment, the recording including: motion, physiological data, or audio;
providing analytics data from the analytics tool to the back-end tool, the analytics data corresponding the recording and including one or more of the analytics tool determining: motion of the person, or an emotion associated with the person;
determining a review to be associated with the person, the review corresponding at least in part to the analytics data and the review including a rating; and
determining if the rating corresponds to a usual result or an unusual result, and if the usual result, pushing the review to a second person in the second environment.

22. The media of claim 21 further including instructions to provide for, if the unusual result, modifying a context associated with the item.

23. The media of claim 21, in which there are at least two sensors in the first environment, the media further including instructions to provide for using sensor fusion of the two sensors to establish a virtual sensor to monitor the person.

24. The media of claim 21 further providing instructions for the analytics tool determining a selected one or more of a detection of: people, gesture, emotion, speech, product interaction, cart placement, historical comparison, or purchase.

25. The media of claim 21 in which the instructions for recording motion of the person including further instructions providing for emitting a selected one or more of: visually record, record a reflection if emit a RF signal, record a reflection if emit a VLC light.
